(19) United States
(12) Patent Application Publication
(10) Pub. No.: US 2005/0238847 A1
(43) Pub. Date: Oct. 27, 2005

(54) Anti-slip wooden floor panel

(76) Inventor: Min-Ju Chung, Taichung Hsien (TW)

Correspondence Address: FROMMER LAWRENCE & HAUG, 745 FIFTH AVENUE- 10TH FL., NEW YORK, NY, 10151, US

(21) Appl. No.: 10/833,749

(22) Filed: Apr. 27, 2004

(51) Int. Cl. B32B 1/00

(52) U.S. Cl. 428/143

(57) ABSTRACT

An anti-slip wooden floor panel includes a wooden substrate, a transparent base coating layer coated on the wooden substrate, a transparent anti-slip coating layer coated on the base coating layer and including a polyurethane matrix and 8-10 wt % of transparent resin particles that are dispersed in the polyurethane matrix and that have a particle size ranging from 85-100 μm, and a transparent cover coating layer coated on the anti-slip coating layer and having a thickness ranging from 0.2-0.3 mm.

### BACKGROUND OF THE INVENTION

1. Field of the Invention

This invention relates to an anti-slip wooden floor panel, more particularly to an anti-slip wooden floor panel having a transparent anti-slip coating layer that includes a transparent polyurethane matrix and 8-10 wt % of transparent resin particles dispersed in the polyurethane matrix.

2. Description of the Related Art

U.S. Pat. No. 4,501,783 discloses a non-slip floor material that comprises a polyvinyl chloride matrix layer and resin particles dispersed in the matrix layer and having a particle size ranging from 100 μm to 1 mm. When the particle size is larger than 1 mm, the resin particles will not be uniformly dispersed in the matrix layer upon mixing therewith, which can result information of obscure spots when the floor material is transparent and is desired to be viewed therethrough. On the other hand, when the particle size is smaller than 100 μm, the resin particles are too fine to provide sufficient anti-slip effect.

### SUMMARY OF THE INVENTION

The object of the present invention is to provide an anti-slip wooden floor panel that is capable of providing sufficient anti-slip without undesirably forming the obscure spots commonly encountered in the aforesaid conventional non-slip floor material.

According to this invention, an anti-slip wooden floor panel comprises: a wooden substrate having a textured surface; a transparent base coating layer coated on the textured surface of the wooden substrate; a transparent anti-slip coating layer coated on the base coating layer and including a transparent polyurethane matrix and 8-10 wt % of transparent resin particles dispersed in the polyurethane matrix so as to provide a sufficient anti-slip effect, the resin particles having a particle size ranging from 85-100 μm so as to be uniformly dispersed in the polyurethane matrix upon mixing therewith and so as to avoid formation of undesired obscure spots when viewing the textured surface of the wooden substrate through the anti-slip coating layer; and a transparent cover coating layer coated on the anti-slip coating layer and having a thickness ranging from 0.2-0.3 mm so as to protect the anti-slip coating layer from wearing without adversely affecting the anti-slip effect provided by the anti-slip coating layer.

### BRIEF DESCRIPTION OF THE DRAWING

Other features and advantages of the present invention will become apparent in the following detailed description of the preferred embodiment of the invention, with reference to the accompanying drawing, in which:

FIG. 1 is a fragmentary sectional view of the preferred embodiment of an anti-slip wooden floor panel according to this invention.

### DETAILED DESCRIPTION OF THE PREFERRED EMBODIMENT

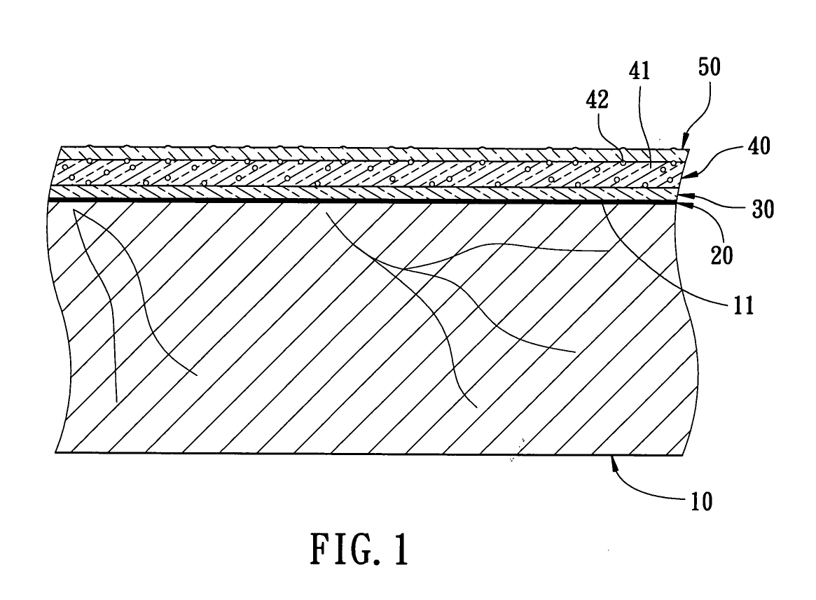

FIG. 1 illustrates the preferred embodiment of an anti-slip wooden floor panel according to this invention.

The anti-slip wooden floor panel includes: a wooden substrate 10 having a textured surface 11; a transparent base coating layer 30 coated on the textured surface 11 of the wooden substrate 10; a transparent anti-slip coating layer 40 coated on the base coating layer 30 and including a transparent polyurethane matrix 41 and 8-10 wt % of transparent resin particles 42 dispersed in the polyurethane matrix 41 so as to provide a sufficient anti-slip effect, the resin particles 42 having a particle size ranging from 85-100 μm so as to be uniformly dispersed in the polyurethane matrix 41 upon mixing therewith and so as to avoid formation of undesired obscure spots when viewing the textured surface 11 of the wooden substrate 10 through the anti-slip coating layer 40; and a transparent cover coating layer 50 coated on the anti-slip coating layer 40 and having a thickness ranging from 0.2-0.3 mm so as to protect the anti-slip coating layer 40 from wearing without adversely affecting the anti-slip effect provided by the anti-slip coating layer 40. Preferably, a transparent colored coating layer 20 is coated on the textured surface 11 of the wooden substrate 10 prior to coating of the base coating layer 30 so as to permit the textured surface 11 of the anti-slip wooden floor panel to exhibit a desired color.

In this embodiment, the base coating layer 30 and the cover coating layer 50 are preferably made from polyurethane. The anti-slip coating layer 40 preferably has a thickness ranging from 0.4-0.6 mm, and more preferably has a thickness of 0.5 mm. The base coating layer preferably has a thickness ranging from 0.2-0.3 mm, and more preferably has a thickness of 0.25 mm.

Preferably, the resin particles are made from polyester resin (PE texture powder), and have a particle size ranging from 90-93 μm.

Preparation of the anti-slip wooden floor panel of this invention can be carried out by the following steps: (a) preparing the wooden substrate 10; (b) applying the colored coating layer 20 on the textured surface 11 of the wooden substrate 10; (c) drying the colored coating layer 20 using an oven (not shown) or through natural wind; (d) applying the base coating layer 30 to the colored coating layer 20; (e) drying the base coating layer 30 using the oven or through natural wind; (f) applying the anti-slip coating layer 40 to the base coating layer 30; (g) drying the anti-slip coating layer 40 using the oven or through natural wind; (h) applying the cover coating layer 50 to the anti-slip coating layer 40; and (i) drying the cover coating layer 50 using the oven or through natural wind. Note that applying of the colored coating layer 20 is omitted when the original color of the wooden substrate 10 is the desired color. When the wooden substrate 10 is to be partially coated with the anti-slip coating layer 40, a cover paper is used to cover the areas, which are not to be coated with the anti-slip coating material, after step (e) and prior to step (f), and is subsequently removed from the wooden substrate 10 after step (g) and prior to step (h).

Bt virtue of the anti-slip coating layer 40, which includes the transparent polyurethane matrix 41 and 8-10 wt % of transparent resin particles 42 uniformly dispersed in the polyurethane matrix 41 and having a particle size ranging from 85-100 μm, the anti-slip wooden floor panel of this invention is capable of providing sufficient anti-slip effect without adversely affecting the appearance of the textured surface 11 of the wooden substrate 10 when viewing through the anti-slip coating layer 40.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

1. An anti-slip wooden floor panel comprising:
a wooden substrate having a textured surface;
a transparent base coating layer coated on said textured surface of said wooden substrate;
a transparent anti-slip coating layer coated on said base coating layer and including a transparent polyurethane matrix and 8-10 wt % of transparent resin particles dispersed in said polyurethane matrix so as to provide a sufficient anti-slip effect, said resin particles having a particle size ranging from 85-100 μm so as to be uniformly dispersed in said polyurethane matrix upon mixing therewith and so as to avoid formation of undesired obscure spots when viewing said textured surface of said wooden substrate through said anti-slip coating layer; and
a transparent cover coating layer coated on said anti-slip coating layer and having a thickness ranging from 0.2-0.3 mm so as to protect said anti-slip coating layer from wearing without adversely affecting the anti-slip effect provided by said anti-slip coating layer.

2. The anti-slip wooden floor panel of claim 1, wherein said base coating layer and said cover coating layer are made from polyurethane.

3. The anti-slip wooden floor panel of claim 2, wherein said anti-slip coating layer has a thickness ranging from 0.4-0.6 mm.

4. The anti-slip wooden floor panel of claim 3, wherein said base coating layer has a thickness ranging from 0.2-0.3 mm.

5. The anti-slip wooden floor panel of claim 4, wherein said resin particles are made from polyester resin.

6. The anti-slip wooden floor panel of claim 5, wherein said particle size ranges from 90-93 μm.

7. The anti-slip wooden floor panel of claim 1, further comprising a transparent colored coating layer coated on said textured surface of said wooden substrate.
